(19) United States
(12) Patent Application Publication
(10) Pub. No.: US 2016/0033701 A1
(43) Pub. Date: Feb. 4, 2016

(54) WIRE GRID POLARIZER AND METHOD OF FABRICATING THE SAME

(71) Applicant: Samsung Display Co. Ltd., Yongin-City (KR)

(72) Inventors: Sung Hoon YANG, Seoul (KR); Shin Il CHOI, Hwaseong-si (KR); Dae Young LEE, Seoul (KR); Gug Rae JO, Asan-si (KR)

(21) Appl. No.: 14/566,140

(22) Filed: Dec. 10, 2014

(30) Foreign Application Priority Data
Jul. 29, 2014 (KR) 10-2014-0096550

(51) Int. Cl. G02B 5/30

(52) U.S. Cl. CPC G02B 5/3058

(57) ABSTRACT

According an embodiment, a wire grid polarizer comprising a substrate, a plurality of conductive wire patterns that are formed on the substrate in a parallel arrangement, a first hard mask and a second hard mask disposed on the conductive wire patterns, and a protective layer formed on the first hard mask and the second hard mask, wherein a ratio of a vertical cross-sectional width of the first hard mask to a vertical cross-sectional width of the second hard mask is 1 or less is provided.

This application claims priority to Korean Patent Application No. 10-2014-0096550 filed on Jul. 29, 2014 in the Korean Intellectual Property Office, the disclosure of which is incorporated herein by reference in its entirety.

### BACKGROUND

1. Related Field

The present disclosure relates to a wire grid polarizer and a method of fabricating the same.

2. Description of the Related Art

An array of conductive wires that are arranged in parallel at a regular interval to extract certain polarized light from electromagnetic waves is generally referred to as a wire grid polarizer. If a wire grid polarizer has a shorter interval than the non-polarized light incident upon it, it reflects the light beams that are incident in parallel to a direction of the wires of the wire grid polarizer and transmits the light beams that are incident perpendicular to the direction of the wires of the wire grid polarizer. The wire grid polarizer may be more beneficial than an absorptive polarizer in that the wire grid polarizer enables the reuse of the reflected, polarized light.

However, if foreign materials other than air infiltrate into the gaps between the wire patterns of a wire grid polarizer, the polarization efficiency of the wire grid polarizer may deteriorate. For example, when foreign materials with a higher refractive index than air infiltrate into the wire grid polarizer, the light transmittance and extinction ratio of the wire grid polarizer with respect to visible light may decrease.

### SUMMARY

Exemplary embodiments of the present system and method provide a wire grid polarizer with improved optical properties, a display device having the wire grid polarizer, and a method of fabricating the wire grid polarizer.

However, exemplary embodiments of the present system and method are not restricted to those set forth herein. The above and other exemplary embodiments of the present system and method are described below to facilitate the understanding of one of ordinary skill in the art to which the present system and method pertains.

According to an exemplary embodiment of the present system and method, there is provided a wire grid polarizer comprising a substrate, a plurality of conductive wire patterns that are formed on the substrate in a parallel arrangement, a first hard mask and a second hard mask disposed on the conductive wire patterns, and a protective layer formed on the first hard mask and the second hard mask, wherein a ratio of a vertical cross-sectional width of the first hard mask to a vertical cross-sectional width of the second hard mask is 1 or less.

According to an exemplary embodiment of the present system and method, there is provided a display device comprising a substrate, a plurality of conductive wire patterns that are formed on the substrate in a parallel arrangement, a first hard mask and a second hard mask disposed on the conductive wire patterns, and a protective layer formed on the first hard mask and the second hard mask, wherein a ratio of a vertical cross-sectional width of the first hard mask to a vertical cross-sectional width of the second hard mask is 1 or less, and wherein a switch device is provided on the protective layer.

According to an exemplary embodiment of the present system and method, there is provided a method of fabricating a wire grid polarizer, the method comprising sequentially depositing a conductive wire pattern layer, a first hard mask layer and a second hard mask layer on a substrate, patterning the first hard mask layer and the second hard mask layer so as to form a first hard mask and a second hard mask, respectively, forming a plurality of conductive wire patterns in the conductive wire pattern layer by using the first hard mask and the second hard mask, and forming a protective layer on the second hard mask, wherein the first hard mask layer and the second hard mask layer have different etching rates.

According to the exemplary embodiments, a wire grid polarizer with improved optical properties is provided. Other features and exemplary embodiments are described below.

### BRIEF DESCRIPTION OF THE DRAWINGS

FIG. 1 is a vertical cross-sectional view of a wire grid polarizer according to an exemplary embodiment of the present system and method.

FIG. 2 is a vertical cross-sectional view of a wire grid polarizer according to another exemplary embodiment of the present system and method.

FIG. 3 is a schematic cross-sectional view of a lower panel of a display device according to an exemplary embodiment of the present system and method.

FIG. 4 is a schematic cross-sectional view of a lower panel of a display device according to another exemplary embodiment of the present system and method.

FIGS. 5 to 9 are cross-sectional views illustrating a method of fabricating a wire grid polarizer, according to an exemplary embodiment of the present system and method.

FIGS. 10 to 15 are cross-sectional views illustrating a method of fabricating a wire grid polarizer, according to another exemplary embodiment of the present system and method.

FIGS. 16 to 19 are cross-sectional views illustrating a method of fabricating a wire grid polarizer, according to another exemplary embodiment of the present system and method.

FIG. 20 is a vertical cross-sectional view of a wire grid polarizer according to another exemplary embodiment of the present system and method.

### DETAILED DESCRIPTION OF THE EMBODIMENTS

Advantages and features of the present system and method are described with reference to exemplary embodiments and the accompanying drawings. However, the present system and method may be embodied in many different forms and, thus, are not limited to the embodiments set forth herein. Rather, these embodiments are provided to help convey the teachings of the present system and method to those skilled in the art.

Like reference numerals refer to like elements throughout the specification. The terminologies used herein are for the purpose of describing particular embodiments and are not intended to be limiting of the present system and method. As used herein, the singular forms “a”, “an” and “the” are intended to include the plural forms as well, unless the context clearly indicates otherwise. It is further understood that the terms “comprises” and/or “comprising,” when used in this specification, specify the presence of, for example, stated features, integers, steps, operations, elements, and/or components, but do not preclude the presence or addition of one or more other features, integers, steps, operations, elements, components, and/or groups thereof.

It is understood that when an element or layer is referred to as being “on”, “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the enumerated items.

It is understood that, although the terms first, second, etc. may be used herein to describe various elements, components, regions, layers and/or sections, these elements, components, regions, layers and/or sections are not limited by these terms. These terms are only used to distinguish one element, component, region, layer or section from another region, layer or section. Thus, a first element may be referred to as a second element without departing from the teachings of the present system and method.

Spatially relative terms, such as “beneath”, “below”, “lower”, “above”, “upper”, and the like, may be used herein for ease of description to describe one element or feature's relationship to another element(s) or feature(s) as illustrated in the figures. It is understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In such case, the exemplary term “below” encompasses both an orientation of above and below, depending on how the device is oriented relative to the orientation shown in the figures. That is, in whichever way the device may be oriented (e.g., rotated 90 degrees or at other orientations) relative to that shown in the figures, the spatially relative descriptors used herein are to be interpreted accordingly.

Embodiments are described herein with reference to cross-section illustrations that are schematic illustrations of exemplary embodiments (and intermediate structures). As such, variations from the shapes of the illustrations as a result, for example, of manufacturing techniques and/or tolerances, are contemplated. Thus, the present system and method are not limited to the particular shapes of regions illustrated herein but include deviations in shapes that result, for example, from manufacturing. For example, an implanted region illustrated as a rectangle well, typically, have rounded or curved features and/or a gradient of implant concentration at its edges rather than a binary change from an implanted to a non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present system and method.

Hereinafter, embodiments of the present system and method are described with reference to the accompanying drawings.

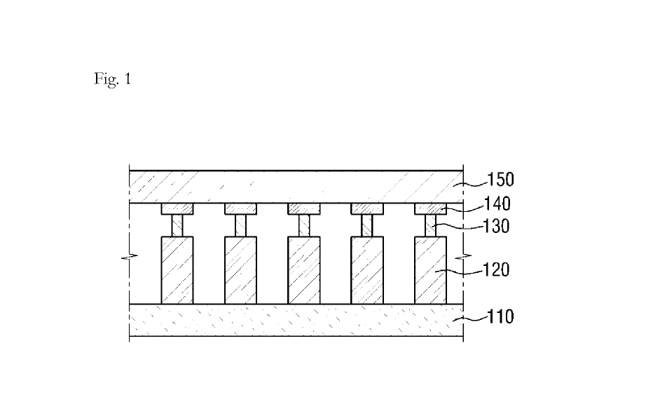

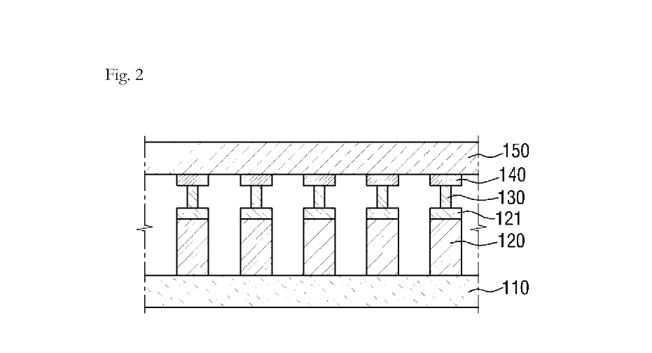

FIG. 1 is a vertical cross-sectional view of a wire grid polarizer according to an exemplary embodiment of the present system and method. FIG. 2 is a vertical cross-sectional view of a wire grid polarizer according to another exemplary embodiment of the present system and method.

Referring to FIG. 1, a wire grid polarizer according to an exemplary embodiment of the present system and method includes a substrate 110, a plurality of first conductive wire patterns 120 formed in parallel on, and protruding from, the substrate 110, a first hard mask 130 and a second hard mask 140 disposed over the first conductive wire patterns 120, and a protective layer 150 formed on the second hard mask 140. The ratio of the vertical cross-sectional width of the first hard mask 130 to the vertical cross-sectional width of the second hard mask 140 is 1 or less.

The substrate 110 may be appropriately selected in consideration of the purpose of use thereof and the type of processing to be performed. For example, the substrate 110 may be formed of glass, quartz or various polymers such as acrylic, triacetyl cellulose (TAC), a cyclic olefin copolymer (COC), a cyclic olefin polymer (COP), polycarbonate (PC), polyethylenenaphthalate (PET), or polyethersulfone (PES), but the present system and method are not limited thereto. The substrate 110 may be implemented as an optical film with a certain degree of flexibility.

The first conductive wire patterns 120 may be arranged in parallel on the substrate 110 at a regular interval. The shorter the interval of the first conductive wire patterns 120 becomes with respect to the wavelength of incident light, the higher the polarized light extinction ratio of the first conductive wire patterns 120 becomes. However, at the same time, it also becomes more difficult to fabricate the first conductive wire patterns 120. The wavelength of visible light generally falls within the range of about 380 nm to about 780 nm. Thus, according to an exemplary embodiment, a wire grid polarizer that has a high extinction ratio with respect to the three primary colors (i.e., red (R), green (G) and blue (B)) of light may be formed with first conductive wire patterns 120 that are arranged at an interval of about 200 nm or less. According to another exemplary embodiment, the first conductive wire patterns 120 may be formed to have an interval of 120 nm or less.

The first conductive wire patterns 120 may be formed of a type of conductive material. In an exemplary embodiment, the first conductive wire patterns 120 may be formed of a metal material, including but not limited to a metal selected from the group consisting aluminum (Al), chromium (Cr), silver (Ag), copper (Cu), nickel (Ni), titanium (Ti), cobalt (Co) and molybdenum (Mo), or an alloy thereof.

The width of the first conductive wire patterns 120 may be set to a range in which the first conductive wire patterns 120 may adequately perform polarization. For example, the width of the first conductive wire patterns 120 may be formed to be in a range of about 10 nm to about 200 nm or 10 nm to about 500 nm. The present system and method, however, are not limited to these ranges.

In an exemplary embodiment, at least one of the first hard mask 130 and the second hard mask 140 may include a hydrophobic material and the protective layer 150 may include a hydrophilic material. For example, the first hard mask 130 may be formed of SiOC, and the second hard mask 140 may be formed of SiNx and/or SiOx. In this exemplary embodiment, because the protective layer 150 is formed of a hydrophilic material, the material of the protective layer 150 may be prevented from infiltrating into the first conductive wire patterns 120. However, the present system and method are not limited to this embodiment.

The first hard mask 130 and the second hard mask 140 may be used as etching masks for patterning the first conductive wire patterns 120. The first hard mask 130 and the second hard mask 140 may have different etching rates (i.e., may be etched at different rates under the same etching conditions). For example, if the etching rate of the first hard mask 130 is higher than the etching rate of the second hard mask 140, the first hard mask 130 may be more etched than the second hard mask 140 under the same etching conditions (e.g., at the same time, in situ, etc.). As a result, the ratio of the vertical cross-sectional width of the first hard mask 130 to the vertical cross-sectional width of the second mask 140 may become 1 or less.

According to an embodiment, the first hard mask 130 and the second hard mask 140 may be formed to a thickness of about 20% to about 30% of the thickness of the first conductive wire patterns 120, but the present system and method are not limited thereto. That is, the thickness of the first hard mask 130 and the second hard mask 140 may be determined according to a set of processing conditions.

The protective layer 150 may be formed as a top surface of the wire grid polarizer using a non-conductive material, so as to planarize the wire grid polarizer. The protective layer 150 may be formed of a type of non-conductive, transparent material, including, for example, at least one selected from the group consisting of SiOx, SiNx and SiOC. In an exemplary embodiment, the protective layer 150 may have a structure in which a SiOC layer is deposited on a SiOx layer. In this exemplary embodiment, the protective layer 150 may be formed through deposition by changing the raw material gases while using the same chamber and the same conditions. This exemplary embodiment may be beneficial in terms of efficiency because the SiOC layer can be deposited relatively quickly.

Referring to FIG. 2, a wire grid polarizer according to another exemplary embodiment of the present system and method may include a plurality of first conductive wire patterns 120 and a plurality of second conductive wire patterns 121 provided on the first conductive wire patterns 120. The wire grid polarizer of FIG. 2 differs from that of FIG. 1 at least in that the wire grid polarizer of FIG. 2 additionally includes the second conductive wire patterns 121. Similar aspects between the two figures are not described extensively to avoid redundancy.

The second conductive wire patterns 121 may be formed of a type of conductive material that is different from the conductive material used to form the first conductive wire patterns 120. In an exemplary embodiment, the second conductive wire patterns 121 may be formed of a metal material, including but not limited to a metal selected from the group consisting Al, Cr, Ag, Cu, Ni, Ti, Co and Mo, or an alloy thereof.

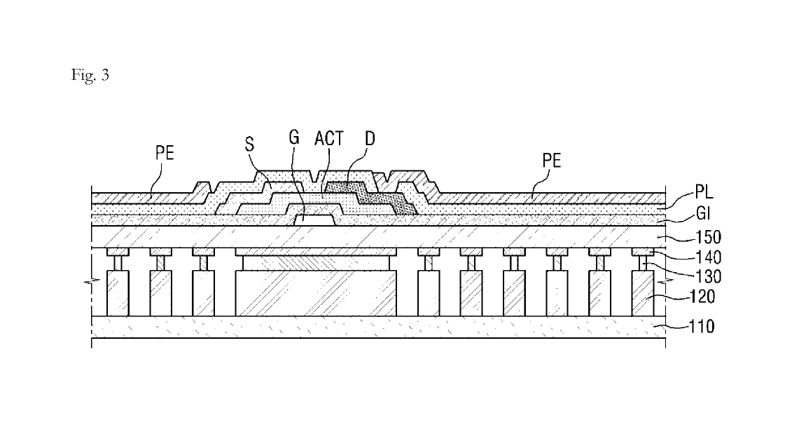

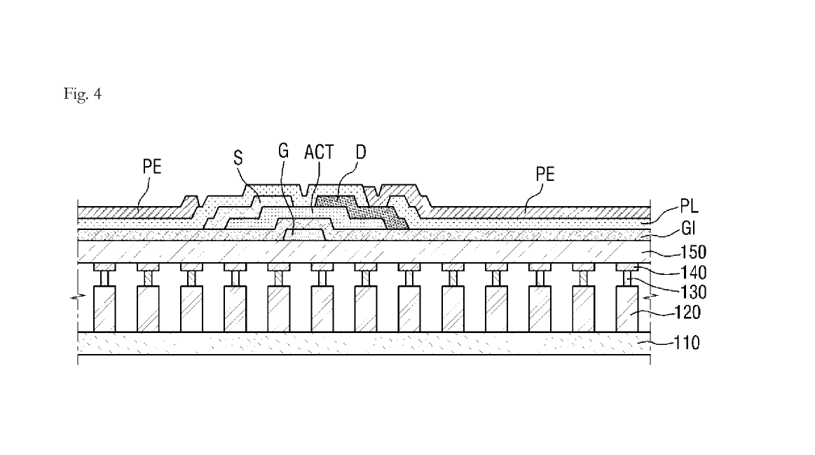

FIG. 3 is a schematic cross-sectional view of a lower panel of a display device according to an exemplary embodiment of the present system and method. FIG. 4 is a schematic cross-sectional view of a lower panel of a display device according to another exemplary embodiment of the present system and method.

Referring to FIG. 3 or 4, a lower panel of a display device according to an exemplary embodiment of the present system and method may be a thin-film transistor (TFT) substrate. The structure of a TFT is described hereinafter. A gate electrode G is disposed on a protective layer 150, and a gate insulating layer GI is disposed on the gate electrode G and the protective layer 150. A semiconductor layer ACT is disposed at least on a region of the gate insulating layer GI that overlaps with the gate electrode G. A source electrode S and a drain electrode D are disposed on the semiconductor layer ACT and isolated from each other. A passivation layer PL is disposed on the gate insulating layer GI, the source electrode S, the semiconductor layer ACT and the drain electrode D. A pixel electrode PE is disposed on the passivation layer PL, and may be electrically connected to the drain electrode D through a contact hole through which the drain electrode D is at least partially exposed. The embodiment of FIG. 3 differs from that of FIG. 4 at least in that the TFT is formed in a region that is free from overlap with the wire grid polarizer.

The TFT is generally provided in a non-display region that does not transmit light therethrough. In the non-display region, a wire grid polarizer may be formed from a metallic material having a high reflectivity, but not in the form of a pattern. The metallic material may serve as a reflective plate and reflect light incident upon the non-display region so that the reflected light may be used in a display region. Accordingly, the luminance of a display device may be improved by including the wire grid polarizer.

A display device according to an exemplary embodiment of the present system and method may also include a backlight unit (not illustrated), a liquid crystal panel (not illustrated), and an upper polarizing plate (not illustrated). The backlight unit may be disposed below the lower substrate and emit light. The liquid crystal panel may include the lower substrate, a liquid crystal layer (not illustrated) and an upper substrate (not illustrated). The upper polarizing plate (not illustrated) may be disposed above the liquid crystal panel.

The transmission axes of the upper polarizing plate and the wire grid polarizer may be orthogonal or parallel to each other. In an exemplary embodiment, the upper polarizing plate may be implemented as a wire grid polarizer, or as a typical polyvinyl alcohol (PVA)-based polarizing film. In another exemplary embodiment, the upper polarizing plate may not be provided.

The backlight unit may include, for example, a light guide plate (LGP) (not illustrated), a light source unit (not illustrated), a reflective member (not illustrated), and one or more optical sheets (not illustrated).

The LGP may be configured to redirect light emitted from the light source unit toward the liquid crystal layer. The LGP may include a light incidence surface upon which light is incident and a light emission surface through which light is emitted toward the liquid crystal layer. The LGP may be formed of a light-transmissive material with a predetermined refractive index, such as polymethyl methacrylate (PMMA) or PC, but the present system and method are not limited thereto.

Light incident upon one or more side surfaces of the LGP may have a smaller incidence angle than the critical angle of the LGP, and may thus enter the LGP. On the other hand, light incident upon the top or bottom surface of the LGP may have a greater incidence angle than the critical angle of the LGP, and may thus be evenly distributed within the LGP, instead of being emitted outwards from the LGP.

A plurality of diffusion patterns may be formed on one of the top and bottom surfaces of the LGP. For example, the bottom surface of the LGP that faces the emission surface may include diffusion patterns to enable guided light to be emitted upwards. The diffusion patterns may be formed on one surface of the LGP, for example, by printing with ink, but the present system and method are not limited thereto. That is, fine grooves or protrusions may be formed on the LGP as the diffusion patterns. Various other modifications may be made to the diffusion patterns without departing from the scope of the present system and method.

A reflective member (not illustrated) may be additionally provided between the LGP and a lower accommodating member (not illustrated). The reflective member reflects light emitted from the bottom surface of the LGP, which is opposite to and faces the emission surface of the LGP, back to the LGP. The reflective member may be formed as a film, but the present system and method are not limited thereto.

The light source unit may be disposed to face the incident surface of the LGP. The number of light source units provided may be appropriately adjusted. For example, in one case, one light source unit may be provided on only one side of the LGP. In another case, three or more light source units may be provided to correspond to three or more sides of the LGP. In yet another case, a plurality of light source units may be provided to correspond to only one side of the LGP. Although the backlight unit is exemplarily described above as a side-light type of backlight unit in which a light source unit is provided on a side of an LGP, the present system and method are not limited thereto. That is, the present system and method are also applicable to a direct-type backlight unit or another light source device, such as a surface-type light source device.

The light source unit may include a white light-emitting diode (LED) that emits white light or a plurality of LEDs that emit red (R) light, green (G) light and blue (B) light. If the light source unit includes a plurality of LEDs emitting R light, G light, and B light, white light may be realized by turning on all the LEDs to provide a uniform mix of R light, G light, and B light together.

The upper substrate may be a color filter (CF) substrate. For example, the upper substrate may include a black matrix, red/green/blue color filters, and a common electrode. The black matrix may be provided at the bottom of a member formed of a transparent insulating material such as glass or plastic to prevent light from leaking across the different color filters. The common electrode is an electric field generating electrode and may be formed of a transparent conductive oxide such as indium tin oxide (ITO) or indium zinc oxide (IZO).

The liquid crystal layer is configured such that when an electric field is applied to its molecules, the polarizing axis of incident light becomes rotated. The liquid crystal molecules are aligned in a predetermined direction in the absence of an electric field and are disposed in the liquid crystal layer between the upper substrate and the lower substrate. The liquid crystal layer may be of a twisted nematic (TN) mode, a vertical alignment (VA) mode, or a horizontal alignment mode (such as an in-plane switching (IPS) mode or a fringe field switching (FFS) mode) with positive dielectric anisotropy, but the present system and method are not limited thereto.

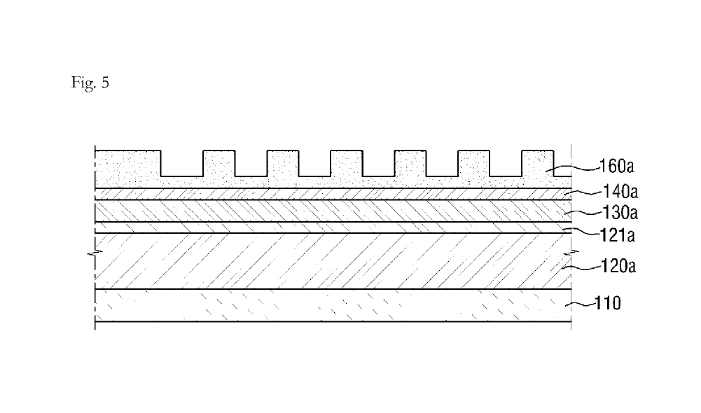

FIGS. 5 to 9 are cross-sectional views illustrating a method of fabricating a wire grid polarizer, according to an exemplary embodiment of the present system and method. Referring to FIG. 5, a first conductive wire pattern layer 120a, a second conductive wire pattern layer 121a, a first hard mask layer 130a, a second hard mask layer 140a and an imprint layer 160a may be deposited on a substrate 110.

The first conductive wire pattern layer 120a, the second conductive wire pattern layer 121a, the first hard mask layer 130a and the second hard mask layer 140a may be formed, for example, by sputtering, chemical vapor deposition (CVD) or evaporation, but the present system and method are not limited thereto.

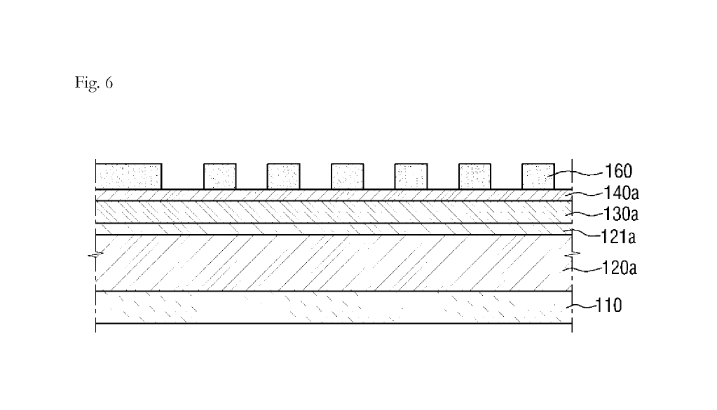

Referring to FIG. 6, the imprint layer 160a may be formed by applying an imprint resin and patterning the imprint resin with the use of an imprint mold. Thereafter, the remaining imprint resin may be removed, thereby forming imprint patterns 160.

By using the imprint patterns 160 as a mask, the first hard mask layer 130a and the second hard mask layer 140a may be etched and patterned. The first hard mask layer 130a and the second hard mask layer 140a may have different etching rates (i.e., may be etched at different rates under the same conditions). For example, the first hard mask layer 130a may have a higher etching rate than the second hard mask layer 140a, in which case, the ratio of the vertical cross-sectional width of a first hard mask 130 to the vertical cross-sectional width of a second hard mask 140 may become 1 or less. Accordingly, the first conductive wire pattern layer 120a and the second conductive wire pattern layer 121a may be etched regardless of the thicknesses of the first hard mask 130 and the second hard mask 140.

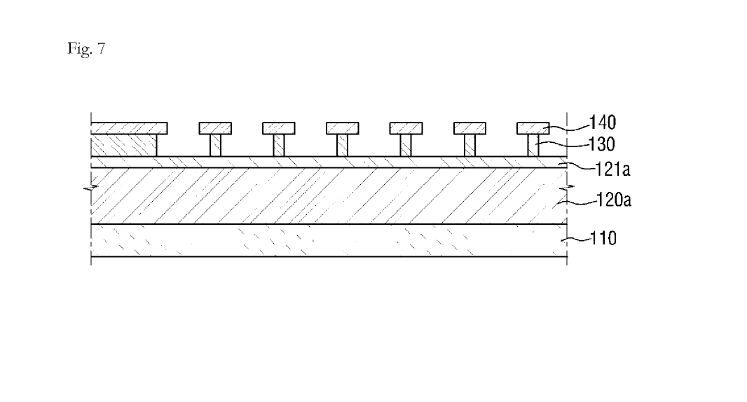

Referring to FIG. 7, the etching of the first hard mask layer 130a and the second hard mask layer 140a may be performed by, for example, dry etching, but the present system and method are not limited thereto. During dry etching, a plasma gas may be appropriately selected in consideration of the material of a layer to be etched. For example, a fluorine-based gas, such as SF₆, CF₄, CHF₃, or C₄F₈, may be used as an etching gas. An additive gas such as O₂, N₂, or H₂ may also be used. In this example, the ratio of the additive gas to the fluorine-based gas may be in the range of 0 to 5.

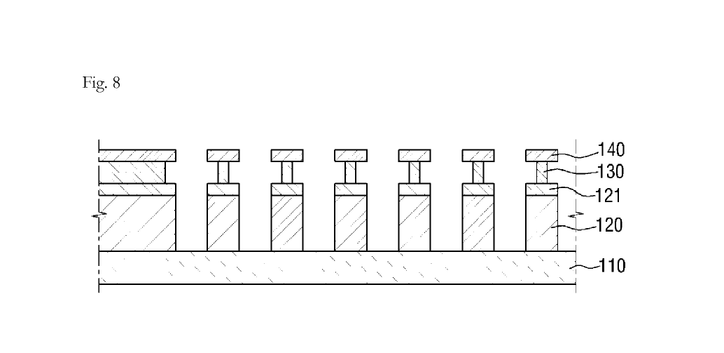

Referring to FIG. 8, by using the first hard mask 130 and the second hard mask 140, the first conductive wire pattern layer 120a and the second conductive wire pattern layer 121a may be etched to form a plurality of first conductive wire patterns 120 and a plurality of second conductive wire patterns 121. A double-layer structure of the first conductive wire patterns 120 and the second conductive wire patterns 121 may be provided, but the present system and method are not limited thereto. That is, a single-layer structure or multilayer structure of a plurality of conductive wire patterns may be provided.

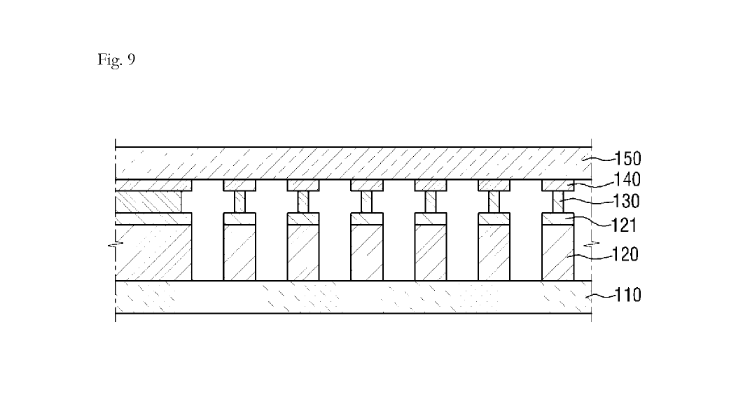

Referring to FIG. 9, a protective layer 150 may be formed on the second hard mask 140, thereby forming a wire grid polarizer with empty spaces between the first conductive wire patterns 120 and between the second conductive wire patterns 121.

As illustrated in FIGS. 5 and 6, fine patterns are not provided in a particular region during the formation of the imprint patterns 160. This allows an un-etched structure to be formed in the first and second conductive wire pattern layers (120a and 121a) under that particular region. That is, instead of fine patterns, the un-etched structure, which may correspond to a metallic layer, may be formed in a region corresponding to a non-display region of a display device. The metallic layer may serve as a reflective layer to improve the luminance of the display device.

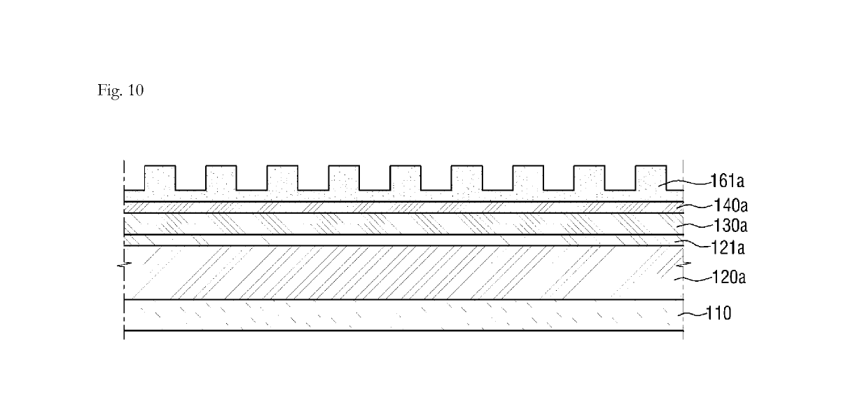

FIGS. 10 to 15 are cross-sectional views illustrating a method of fabricating a wire grid polarizer, according to another exemplary embodiment of the present system and method.

Referring to FIG. 10, a first conductive wire pattern layer 120a, a second conductive wire pattern layer 121a, a first hard mask layer 130a, a second hard mask layer 140a and an imprint layer 161a may be deposited on a substrate 110.

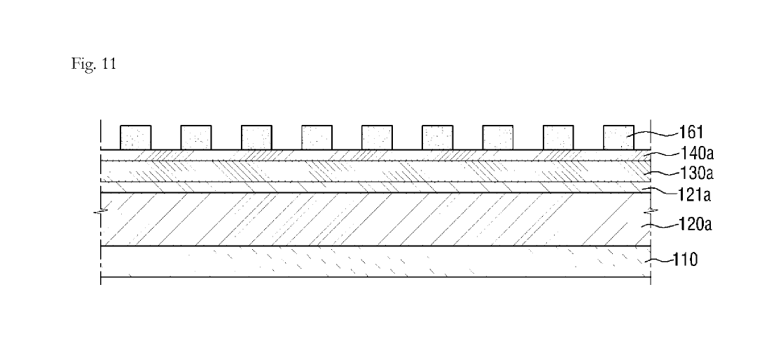

Referring to FIG. 11, any remaining imprint resin may be removed to form imprint patterns 161. That is, fine patterns may be formed in an entire region of a wire grid polarizer as the imprint patterns 161.

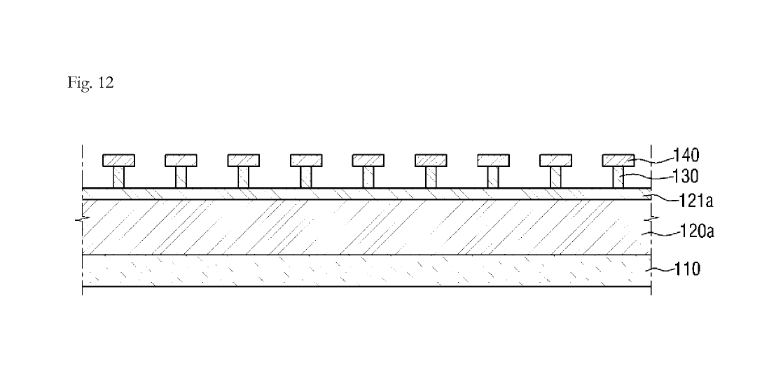

Referring to FIG. 12, by using the imprint patterns 161 as a mask, the first hard mask layer 130a and the second hard mask layer 140a may be etched and patterned. The first hard mask layer 130a and the second hard mask layer 140a may have different etching rates (i.e., may be etched at different rates under the same conditions). For example, the first hard mask layer 130a may have a higher etching rate than the second hard mask layer 140a, in which case, the ratio of the vertical cross-sectional width of a first hard mask 130 to the vertical cross-sectional width of a second hard mask 140 may become 1 or less.

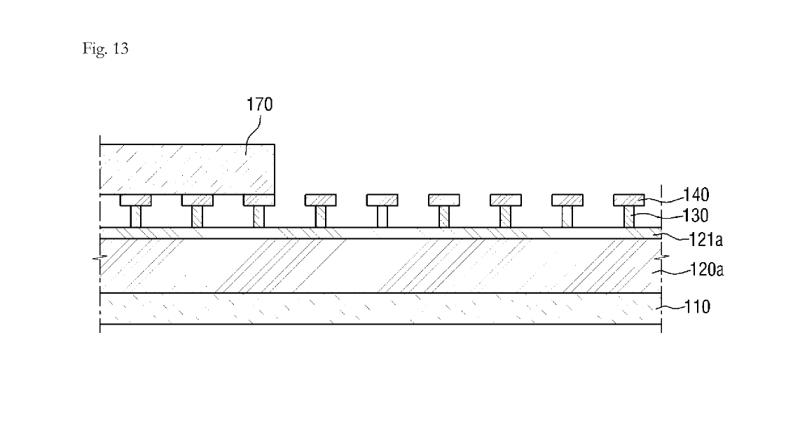

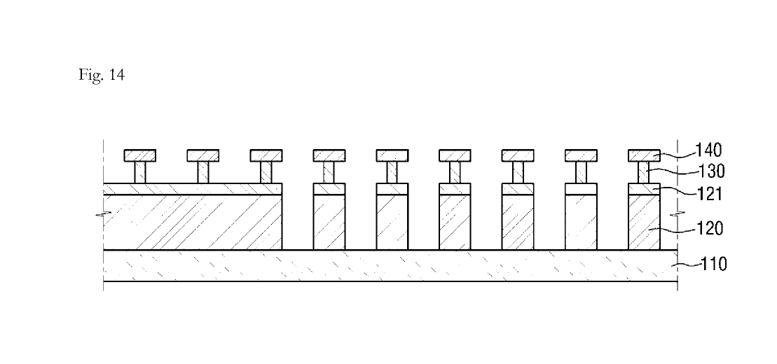

Referring to FIG. 13, after the formation of the first hard mask 130 and the second hard mask 140 through patterning, a photoresist 170 may be formed in a predetermined region. By using the photoresist 170, the first hard mask 130 and the second hard mask 140 as masks, the first conductive wire pattern layer 120a and the second conductive wire pattern layer 121a may be etched. FIG. 14 shows that, as a result, neither a plurality of first conductive wire patterns 120 nor a plurality of second conductive wire patterns 121 are formed in the region where the photoresist 170 is provided. That is, the region where the photoresist 170 is provided is free from overlap with the plurality of conductive wire patterns. The region may correspond to where a switch device is positioned. Accordingly, an un-etched structure is formed in the first and second wire pattern layers (120a and 121a) under where the photoresist 170 is provided. The un-etched structure may serve as a reflective layer in a region corresponding to a non-display region of a display device, thereby improving the luminance of the display device.

In an exemplary embodiment, a reflective layer structure may be provided in a wire grid polarizer, as illustrated in FIGS. 10 to 15. In an alternative exemplary embodiment, fine patterns may be formed in the entire region of a wire grid polarizer.

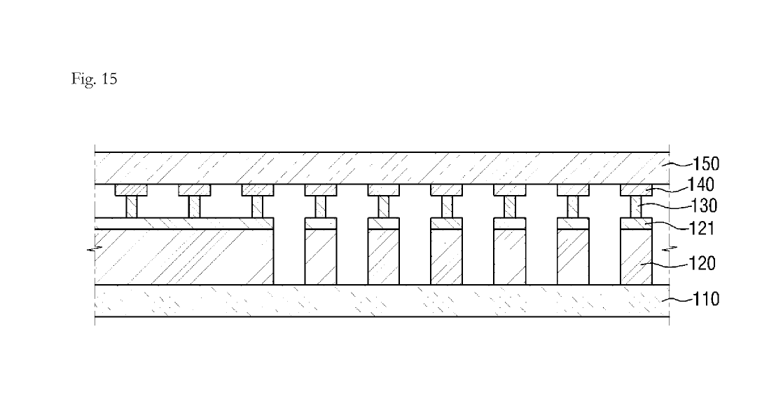

Referring to FIG. 15, a protective layer 150 may be formed on the second hard mask 140, thereby forming a wire grid polarizer with empty spaces between the first conductive wire patterns 120 and between the second conductive wire patterns 121.

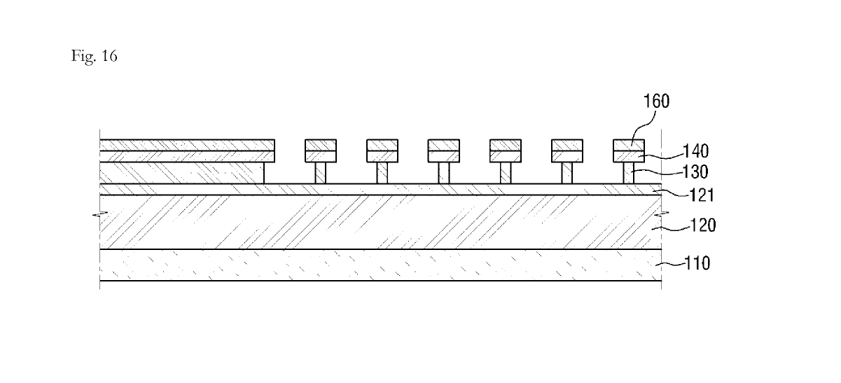

FIGS. 16 to 19 are cross-sectional views illustrating a method of fabricating a wire grid polarizer, according to another exemplary embodiment of the present system and method.

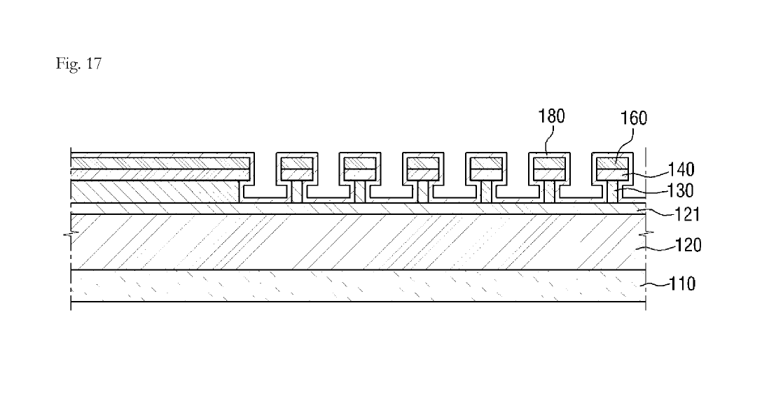

Referring to FIG. 16, at least some imprint patterns 160 may remain on a second hard mask 140 after the formation of a first hard mask 130 and the second hard mask 140 through etching. Referring to FIG. 17, a hydrophobic surface treatment process may be additionally performed after the formation of the first hard mask 130 and the second hard mask 140. In accordance with an embodiment, the hydrophobic surface treatment process may involve forming a fluorine-based layer. The fluorine-based layer may be formed by plasma treatment with the use of a fluorine-based gas, such as SF₆, NF₃, CF₄, or SiF₄, but the present system and method are not limited thereto.

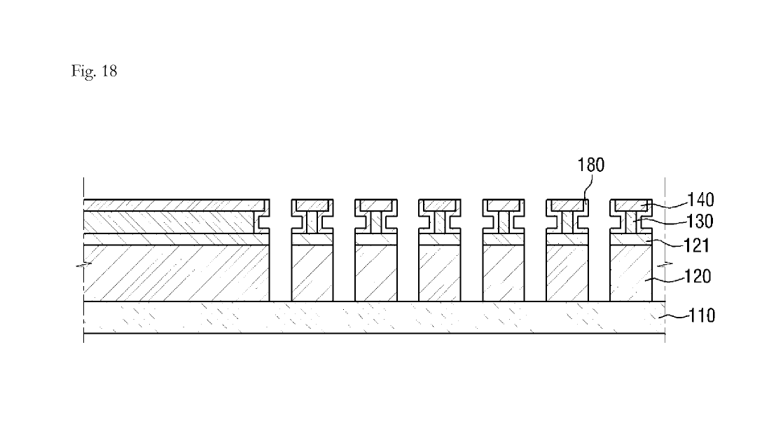

Referring to FIG. 18, the remaining imprint patterns 160 on the second hard mask 140 and the hydrophobic layer on each of the remaining imprint patterns 160 may be removed during the formation of a plurality of first conductive wire patterns 120 and a plurality of second conductive wire patterns 121 through etching. Although the remaining imprint patterns 160 on the second hard mask 140 and the hydrophobic layer on each of the remaining imprint patterns 160 (illustrated in FIG. 17) are shown to be completely removed in FIG. 18, the present system and method are not limited thereto. That is, some of the remaining imprint patterns 160 and part of the hydrophobic layer on each of the remaining imprint patterns 160 may still remain even after the formation of the first conductive wire patterns 120 and the second conductive wire patterns 121.

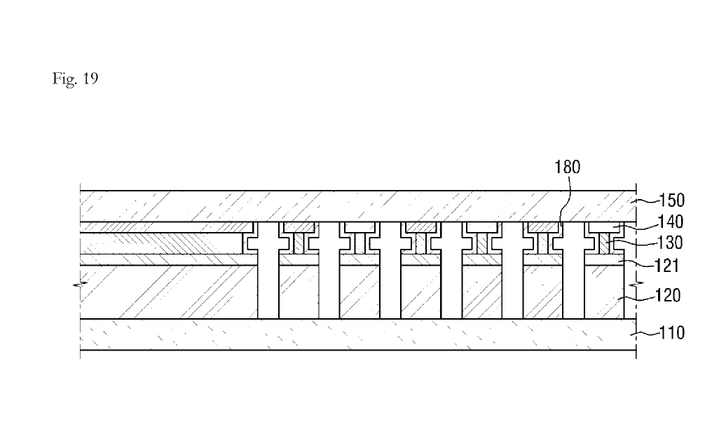

Referring to FIG. 19, a protective layer 150 may be formed on the second hard mask 140, thereby forming a wire grid polarizer. Since the surfaces of the first hard mask 130 and the second hard mask 140 are at least partially hydrophobic-surface-treated, the material of the protective layer 150 may be prevented from infiltrating into the spaces between the first conductive wire patterns 120 and between the second conductive wire patterns 121 during the formation of the protective layer 150.

The protective layer 150 may be formed, for example, of SiOx, SiNx and SiOC. While the protective layer 150 is shown to be formed as a single layer, it may also be formed as two or more layers. For example, the protective layer 150 may be formed by forming a SiOx layer and then a SiOC layer. Accordingly, the protective layer 150 may be formed by changing raw material gases while using the same chamber and the same conditions. Also, since the formation of the protective layer 150 involves forming the SiOC layer, which can be deposited relatively quickly, the efficiency of processing may be improved. Also, since the SiOx layer, which is relatively hydrophilic, is formed first on the hydrophobic-surface-treated surfaces of the first hard mask 130 and the second hard mask 140, the amount by which impurities may infiltrate into the spaces between the first conductive wire patterns 120 and between the second conductive wire patterns 121 may be reduced.

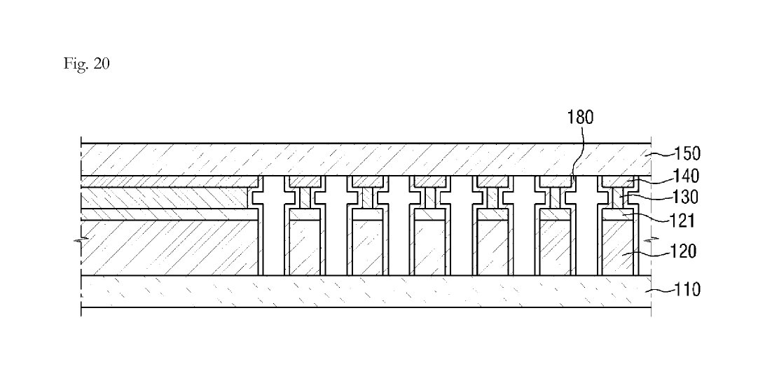

FIG. 20 is a vertical cross-sectional view of a wire grid polarizer according to another exemplary embodiment of the present system and method. Referring to FIG. 20, a wire grid polarizer includes a plurality of first conductive wire patterns 120 and second conductive wire patterns 121. Since hydrophobic surface treatment is performed after the formation of the first conductive wire patterns 120 and the second conductive wire patterns 121 through etching, a hydrophobic layer is formed on the first conductive wire patterns 120 and the second conductive wire patterns 121.

Even though not specifically illustrated in FIG. 20, the hydrophobic layer may also be formed on a second hard mask 140 and at the bottom of the trenches between the first conductive wire patterns 120 and between the second conductive wire patterns 121.

While the present system and method are shown and described with reference to exemplary embodiments, it is understood by those of ordinary skill in the art that various changes may be made therein without departing from the spirit and scope of the present system and method. That is, the present system and method are not limited to the disclosed exemplary embodiments.

What is claimed is:

1. A wire grid polarizer, comprising:
a substrate;
a plurality of conductive wire patterns that are formed on the substrate in a parallel arrangement;
a first hard mask and a second hard mask disposed on the conductive wire patterns; and
a protective layer formed on the first hard mask and the second hard mask,
wherein a ratio of a vertical cross-sectional width of the first hard mask to a vertical cross-sectional width of the second hard mask is 1 or less.

2. The wire grid polarizer of claim 1, wherein at least one of the first hard mask and the second hard mask includes a hydrophobic material.

3. The wire grid polarizer of claim 1, wherein an etching rate of the first hard mask is different from an etching rate of the second hard mask.

4. The wire grid polarizer of claim 3, wherein the etching rate of the first hard mask is higher than the etching rate of the second hard mask.

5. The wire grid polarizer of claim 1, further comprising:
a hydrophobic layer formed on a side of the second hard mask.

6. A display device, comprising:
a substrate;
a plurality of conductive wire patterns that are formed on the substrate in a parallel arrangement;
a first hard mask and a second hard mask disposed on the conductive wire patterns; and
a protective layer formed on the first hard mask and the second hard mask,
wherein a ratio of a vertical cross-sectional width of the first hard mask to a vertical cross-sectional width of the second hard mask is 1 or less, and
wherein a switch device is provided on the protective layer.

7. The display device of claim 6, wherein the wire grid polarizer includes a region corresponding to the switch device that is free from overlap with the plurality of conductive wire patterns.

8. A method of fabricating a wire grid polarizer, the method comprising:
sequentially depositing a conductive wire pattern layer, a first hard mask layer and a second hard mask layer on a substrate;
patterning the first hard mask layer and the second hard mask layer so as to form a first hard mask and a second hard mask, respectively;
forming a plurality of conductive wire patterns in the conductive wire pattern layer by using the first hard mask and the second hard mask; and
forming a protective layer on the second hard mask, wherein the first hard mask layer and the second hard mask layer have different etching rates.

9. The method of claim 8, wherein patterning the first hard mask layer and the second hard mask layer comprises patterning the first hard mask layer and the second hard mask layer in situ.

10. The method of claim 8, wherein patterning the first hard mask layer and the second hard mask layer comprises not patterning at least parts of the first hard mask layer and the second hard mask layer.

11. The method of claim 8, further comprising:
forming a patterned resist layer on the first hard mask and the second hard mask after the patterning the first hard mask layer and the second hard mask layer.

12. The method of claim 8, further comprising:
performing a hydrophobic surface treatment process after the patterning the first hard mask layer and the second hard mask layer.

13. The method of claim 12, wherein performing the hydrophobic surface treatment process, comprises forming a fluorine-based layer.

14. The method of claim 13, wherein performing the hydrophobic surface treatment process further comprises performing plasma treatment with the use of a fluorine-based gas.

15. The method of claim 8, further comprising:
performing a hydrophobic surface treatment process after the forming the conductive wire patterns.

16. The method of claim 15, wherein performing the hydrophobic surface treatment process comprises forming a fluorine-based layer.

17. The method of claim 16, wherein performing the hydrophobic surface treatment process further comprises performing plasma treatment with the use of a fluorine-based gas.
